(19) United States
(12) Patent Application Publication
(10) Pub. No.: US 2026/0221665 A1
(43) Pub. Date: Jul. 30, 2026

(54) RADIO WAVE REFRACTING PLATE

(71) Applicant: KYOCERA Corporation, Kyoto-shi, Kyoto (JP)

(72) Inventors: Kengo SUGIYAMA, Fujisawa-shi, Kanagawa (JP); Nobuki HIRAMATSU, Yokohama-shi, Kanagawa (JP); Masamichi YONEHARA, Yokohama-shi, Kanagawa (JP)

(21) Appl. No.: 19/149,193

(22) PCT Filed: Jan. 15, 2024
(86) PCT No.: PCT/JP2024/000797

§ 371 Date: Jul. 18, 2025

(30) Foreign Application Priority Data
Jan. 31, 2023 (JP) 2023-013240

(51) Int. Cl. H01Q 15/00; H01Q 3/46

(52) U.S. Cl. CPC H01Q 15/0013; H01Q 3/46

(57) ABSTRACT

A radio wave refracting plate includes: a plurality of unit structures arrayed in a first surface direction; and a plurality of radio wave refraction regions including the plurality of unit structures and having different refraction angles in a first angular direction with respect to a radio wave.

### TECHNICAL FIELD

The present disclosure relates to a radio wave refracting plate.

### BACKGROUND OF INVENTION

There is known a technique of controlling electromagnetic waves without using a dielectric lens. For example, Patent Document 1 describes a technique of refracting radio waves in a structure including an array of resonator elements by changing parameters of the respective resonator elements.

### CITATION LIST

### Patent Literature

Patent Document 1: JP 2015-231182 A

### SUMMARY

The present disclosure discloses a radio wave refracting plate including: a plurality of unit structures arrayed in a first surface direction; and a plurality of radio wave refraction regions including the plurality of unit structures and having different refraction angles in a first angular direction with respect to a radio wave.

### BRIEF DESCRIPTION OF THE DRAWINGS

FIG. 1 illustrates a configuration example of a radio wave refracting plate according to each embodiment.

FIG. 2 illustrates a method of using the radio wave refracting plate.

FIG. 3 illustrates a configuration example of a radio wave refracting plate according to a first embodiment.

FIG. 4 illustrates the beam width of a refracted wave according to the first embodiment.

FIG. 5 illustrates a configuration example of a radio wave refracting plate according to a second embodiment.

FIG. 6 illustrates a method of refracting a radio wave with a radio wave refracting plate according to a third embodiment.

FIG. 7 shows the refraction angle of a radio wave refraction region according to the third embodiment.

FIG. 8 shows a gain characteristic of a refracted wave according to a comparative example of a fourth embodiment.

FIG. 9 illustrates a configuration example of a radio wave refracting plate according to a fourth embodiment.

FIG. 10 shows a gain characteristic of a refracted wave according to the fourth embodiment.

FIG. 11 illustrates the refraction angle in a first direction of a radio wave refracting plate according to a fifth embodiment.

FIG. 12 shows a gain characteristic of a refracted wave in the first direction of the radio wave refracting plate according to the fifth embodiment.

FIG. 13 illustrates the refraction angle in a second direction of the radio wave refracting plate according to the fifth embodiment.

FIG. 14 illustrates the refraction angle in the second direction of the radio wave refracting plate according to the fifth embodiment.

### DESCRIPTION OF EMBODIMENTS

In the following, embodiments of the present invention will be described in detail with reference to the accompanying drawings. Note that the present disclosure is not limited by the embodiments, and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X axis in a horizontal plane is defined as an X-axis direction, a direction parallel to a Y axis orthogonal to the X axis in the horizontal plane is defined as a Y-axis direction, and a direction parallel to a Z axis orthogonal to the horizontal plane is defined as a Z-axis direction. In the following description, the X-axis direction and the Y-axis direction are directions parallel to the ground, and the Z-axis direction is a height direction from the ground. A plane including the X axis and the Y axis is appropriately referred to as an XY plane, a plane including the X axis and the Z axis is appropriately referred to as an XZ plane, and a plane including the Y axis and the Z axis is appropriately referred to as a YZ plane. The XY plane is parallel to the horizontal plane. The XY plane, the XZ plane, and the YZ plane are orthogonal to each other.

### EMBODIMENT

### Radio Wave Refracting Plate

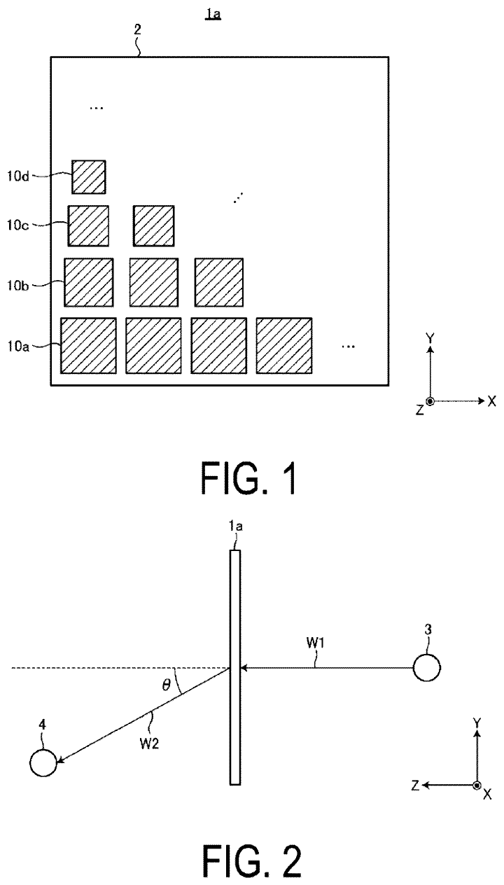

A configuration example of a radio wave refracting plate according to each embodiment will be described with reference to FIG. 1. FIG. 1 illustrates a configuration example of a radio wave refracting plate according to each embodiment.

A radio wave refracting plate 1a is a plate-shaped member configured to be permeable to a radio wave transmitted from a base station. For example, the radio wave refracting plate 1a is configured to, for example, receive the radio wave transmitted from the base station, refract the radio wave at a predetermined angle, and emit a radio wave. The radio wave refracting plate 1a may be made of, for example, a metamaterial that changes the phase of an incident wave.

As illustrated in FIG. 1, the radio wave refracting plate 1a may include a substrate 2, unit structures 10a, unit structures 10b, unit structures 10c, and unit structures 10d.

The unit structures 10a, the unit structures 10b, the unit structures 10c, and the unit structures 10d may be formed on the substrate 2. The substrate 2 may be, for example, a dielectric substrate made of a dielectric body. The substrate 2 may have a rectangular shape, for example, but is not limited thereto. The unit structures 10a, the unit structures 10b, the unit structures 10c, and the unit structures 10d may be two dimensionally arrayed on the substrate 2. The method of arraying the unit structures 10a, the unit structures 10b, the unit structures 10c, and the unit structures 10d may be referred to as phase distribution.

Specifically, on the substrate 2, a plurality of unit structures 10a may be arranged in a line in the bottom row of the substrate 2. On the substrate 2, a plurality of unit structures 10b may be arranged in a line above the row where the unit structures 10a are arranged. On the substrate 2, a plurality of unit structures 10c may be arranged in a line above the row where the unit structures 10b are arranged. On the substrate 2, a plurality of unit structures 10d may be arranged in a line above the row where the unit structures 10c are arranged. That is, the radio wave refracting plate 1 may have a structure in which a plurality of unit structures having different sizes are periodically arrayed. The unit structures 10a to 10d may be different from each other in a frequency band and a change amount in a phase of the radio wave to be changed. The unit structures 10a to 10d have rectangular shapes, but are not limited thereto. The frequency band and the change amount in a phase of the radio wave to be refracted can be adjusted by varying the sizes and shapes of the unit structure 10a, the unit structure 10b, the unit structure 10c, and the unit structure 10d.

FIG. 2 illustrates a method of using the radio wave refracting plate. As illustrated in FIG. 2, the radio wave refracting plate 1 is configured to refract a radio wave W1, which is transmitted from a base station 3, at a predetermined angle and emit a refracted wave W2 to a reception device 4. In the present disclosure, an angle between a straight line obtained by projecting the refracted wave W2 onto the XZ plane and the Z axis is defined as θ, and an angle between a straight line obtained by projecting the refracted wave W2 onto the XY plane and the Y axis is defined as φ.

The phase distribution of the radio wave refracting plate 1a is set according to the desired angle θ and angle φ. Usually, the phase distribution of the radio wave refracting plate 1a is determined based on the following expression (1).

$$\begin{matrix}[ Math 1 ] & \\ Δ Φ = - {kd}_{x} ( sin θ cos ϕ ) - {kd}_{y} ( sin θ sin ϕ ) & ( 1 )\end{matrix}$$

In the expression (1), ΔΦ is a phase difference between adjacent unit structures, k is a wave number of a radio wave, dx is a distance between adjacent unit structures in the X direction, and dy is a distance between adjacent unit structures in the Y direction.

However, there is an issue that the refracted wave W2 emitted from the radio wave refracting plate 1a designed based on the expression (1) has a narrow beam width in the far-field region. In this case, when the reception device 4 is installed in the far-field region, the reception device 4 may not be able to appropriately receive the refracted wave W2. Therefore, the present disclosure provides a radio wave refracting plate capable of widening the beam width of the refracted wave W2 even in the far-field region.

### First Embodiment

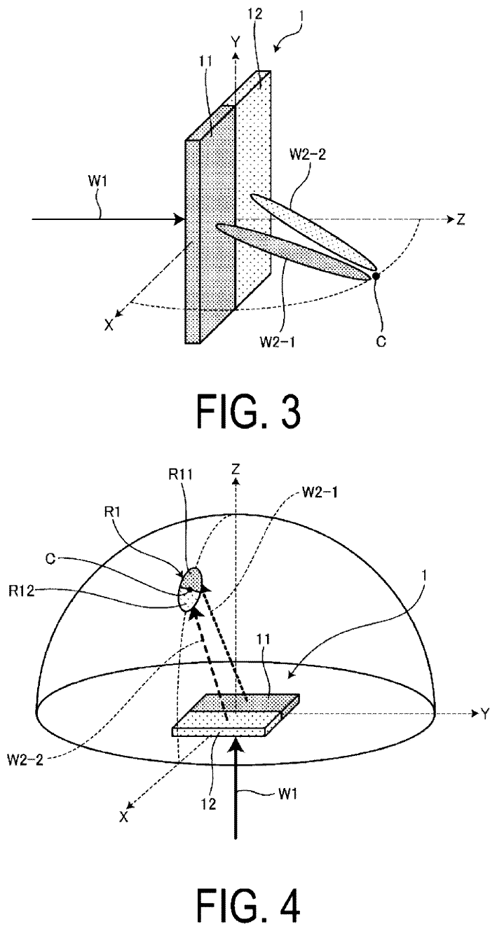

A configuration example of a radio wave refracting plate according to a first embodiment will be described with reference to FIG. 3. FIG. 3 illustrates a configuration example of a radio wave refracting plate according to a first embodiment.

As illustrated in FIG. 3, a radio wave refracting plate 1 includes a first radio wave refraction region 11 and a second radio wave refraction region 12. The radio wave refracting plate 1 is configured to receive the radio wave W1 transmitted from the base station 3, and emit waves toward the vicinity of a point C in the XZ plane (refractive surface). The radio wave refracting plate 1 is divided in the Y-axis direction (horizontal direction) on the XY plane.

The first radio wave refraction region 11 and the second radio wave refraction region 12 are regions obtained by dividing the radio wave refracting plate 1 perpendicularly to the refractive surface. The first radio wave refraction region 11 is configured to refract the received radio wave W1 and emit a refracted wave W2-1 toward the vicinity of the point C. The second radio wave refraction region 12 is configured to refract the received radio wave W1 and emit a refracted wave W2-2 toward the vicinity of the point C.

The first radio wave refraction region 11 and the second radio wave refraction region 12 are configured such that the refraction angles of the radio wave W1 are different. For example, the first radio wave refraction region 11 and the second radio wave refraction region 12 are configured to have different phase distributions so that the refraction angles of the radio wave W1 are different. That is, the refraction angles of the radio wave W1 in the first radio wave refraction region 11 and the second radio wave refraction region 12 can be set independently. In the first embodiment, by setting the refraction angle of the radio wave W1 for each radio wave refraction region, it is possible to widen the beam width in the 0 direction of the refracted wave toward the point C.

FIG. 4 illustrates the beam width of a refracted wave according to the first embodiment. As illustrated in FIG. 4, the first radio wave refraction region 11 emits a refracted wave W2-1 obtained by refracting the radio wave W1 toward the vicinity of the point C. A region R11 indicates the beam width of the refracted wave W2-1 on a hemispherical surface including the point C. The second radio wave refraction region 12 emits a refracted wave W2-2 obtained by refracting the radio wave W1 toward the vicinity of the point C. A region R12 indicates the beam width of the refracted wave W2-2 on a hemispherical surface including the point C. A region R1 indicates the beam width, on a hemispherical surface including the point C, of a refracted wave obtained by the radio wave refracting plate 1 refracting the radio wave W1. The region R1 is a region obtained by combining the region R11 and the region R12. The region R11 and the region R12 are arranged in the θ direction. That is, in the first embodiment, by dividing the radio wave refracting plate 1 into a plurality of radio wave refraction regions such as the first radio wave refraction region 11 and the second radio wave refraction region 12, the beam width in the θ direction on a hemispherical surface including the point C can be widened.

The first radio wave refraction region 11 and the second radio wave refraction region 12 may have the same size or different sizes. The first radio wave refraction region 11 and the second radio wave refraction region 12 may be formed by, for example, forming two regions having different phase distributions in one radio wave refracting plate 1. For example, the first radio wave refraction region 11 and the second radio wave refraction region 12 may be formed by arranging two radio wave refracting plates having different phase distributions. When the first radio wave refraction region 11 and the second radio wave refraction region 12 are formed by two radio wave refracting plates, the two radio wave refracting plates may be arranged so as to be in contact with each other, or may be arranged with a predetermined interval therebetween.

In the first embodiment, the radio wave refracting plate 1 has been described as including two radio wave refraction regions of the first radio wave refraction region 11 and the second radio wave refraction region 12, but the present disclosure is not limited thereto. The radio wave refracting plate 1 may include three or more radio wave refraction regions.

As described above, in the first embodiment, the radio wave refracting plate 1 includes a plurality of radio wave refraction regions that are perpendicular to the refractive surface and have different refraction angles of the radio wave W1. Accordingly, in the first embodiment, the beam width of the refracted wave refracted by the radio wave refracting plate 1 in the far region can be widened.

### Second Embodiment

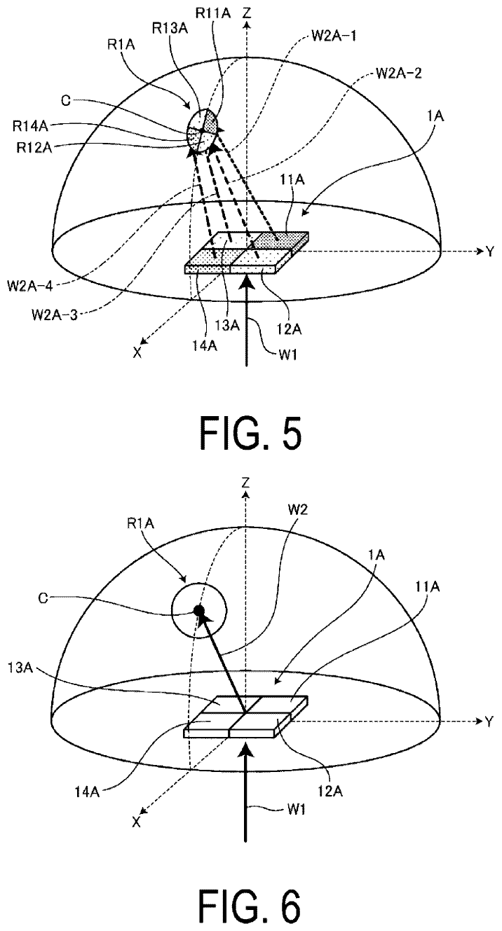

A configuration example of a radio wave refracting plate according to a second embodiment will be described with reference to FIG. 5. FIG. 5 illustrates a configuration example of a radio wave refracting plate according to a second embodiment.

As illustrated in FIG. 5, a radio wave refracting plate 1A includes a first radio wave refraction region 11A, a second radio wave refraction region 12A, a third radio wave refraction region 13A, and a fourth radio wave refraction region 14A. The radio wave refracting plate 1A is divided in both the X-axis direction (vertical direction) and the Y-axis direction (horizontal direction) on the XY plane.

The first radio wave refraction region 11A is configured to refract the radio wave W1 and emit a refracted wave W2A-1 toward the vicinity of the point C. The second radio wave refraction region 12A is configured to refract the radio wave W1 and emit a refracted wave W2A-2 toward the vicinity of the point C. The third radio wave refraction region 13A is configured to refract the radio wave W1 and emit a refracted wave W2A-3 toward the vicinity of the point C. The fourth radio wave refraction region 14A is configured to refract the radio wave W1 and emit a refracted wave W2A-4 toward the vicinity of the point C.

The first radio wave refraction region 11A to the fourth radio wave refraction region 14A are configured to have different refraction angles of the radio wave W1. For example, the first radio wave refraction region 11A to the fourth radio wave refraction region 14A are configured to have different refraction angles of the radio wave W1 by having different phase distributions. That is, the first radio wave refraction region 11A to the fourth radio wave refraction region 14A can have independently set refraction angles of the radio wave W1. In the second embodiment, by setting the refraction angle of the radio wave W1 for each radio wave refraction region, it is possible to widen the beam width in the θ direction and the φ direction of the refracted wave on a hemispherical surface including the point C.

A region R11A indicates the beam width of the refracted wave W2A-1 on a hemispherical surface including the point C. A region R12A indicates the beam width of the refracted wave W2A-2 on a hemispherical surface including the point C. A region R13A indicates the beam width of the refracted wave W2A-3 on a hemispherical surface including the point C. A region R14A indicates the beam width of the refracted wave W2A-4 on a hemispherical surface including the point C. The region RIA is a region obtained by combining the region R11A, the region R12A, the region R13A, and the region R14A. The region R11A and the region R12A are arranged in the θ direction. The region R13A and the region R14A are arranged in the θ direction. The region R11A and the region R13A are arranged in the φ direction. The region R12A and the region R14A are arranged in the φ direction. The regions R11A and R12A and the regions R13A and R14A are arranged in a direction perpendicular to the refractive surface. The regions R11A and R13A and the regions R12A and R14A are arranged in a direction parallel to the refractive surface. That is, in the second embodiment, by dividing the radio wave refracting plate 1A into a plurality of radio wave refraction regions such as the first radio wave refraction region 11A to the fourth radio wave refraction region 14A, the beam width in the θ direction and the φ direction on a hemispherical surface including the point C can be widened.

The first radio wave refraction region 11A to the fourth radio wave refraction region 14A may have the same size or different sizes. The first radio wave refraction region 11A to the fourth radio wave refraction region 14A may be formed by, for example, forming four regions having different phase distributions in one radio wave refracting plate 1A. For example, the first radio wave refraction region 11A to the fourth radio wave refraction region 14A may be formed by arranging four radio wave refracting plates having different phase distributions. When the first radio wave refraction region 11A to the fourth radio wave refraction region 14A are formed by four radio wave refracting plates, the four radio wave refracting plates may be arranged so as to be in contact with each other, or may be arranged at predetermined intervals.

In the second embodiment, the radio wave refracting plate 1A has been described as including four radio wave refraction regions of the first radio wave refraction region 11A to the fourth radio wave refraction region 14A, but the present disclosure is not limited thereto. The radio wave refracting plate 1A may include five or more radio wave refraction regions.

As described above, in the second embodiment, the radio wave refracting plate 1A includes a plurality of radio wave refraction regions that are perpendicular and parallel to the refractive surface and have different refraction angles of the radio wave W1. Accordingly, in the second embodiment, the beam width of the refracted wave refracted by the radio wave refracting plate 1A in the far region can be widened more appropriately.

### Third Embodiment

FIG. 6 illustrates a method of refracting a radio wave with a radio wave refracting plate according to a third embodiment. For example, if the point C, which is the center of the region in which the refracted wave is desired to be spread, is included in the beam width in the θ direction and the φ direction of the refracted wave from each of the first radio wave refraction region 11A to the fourth radio wave refraction region 14A, the received power at the position of the point C becomes larger than necessary, and as a result, the beam width of the refracted wave in the direction of the point C may become narrower.

In the third embodiment, the refraction angle is set such that the point C is not included in the beam width in both the θ direction and the φ direction of the refracted wave from at least one radio wave refraction region among the plurality of radio wave refraction regions. In the third embodiment, the refraction angle of the radio wave refraction region that emits the refracted wave set such that the point C is not included in the beam width thereof is set so as to overlap within a half-width with the refracted wave from the radio wave refraction region set such that the point C is included in the beam width thereof in both the θ direction and the φ direction.

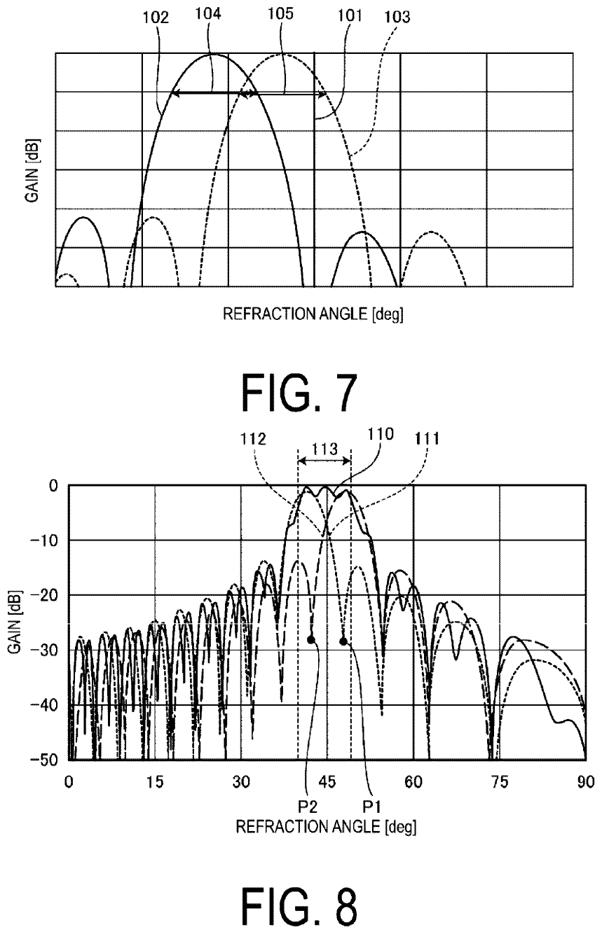

FIG. 7 shows the refraction angle of a radio wave refraction region according to the third embodiment. In FIG. 7, the horizontal axis represents the refraction angle [deg (degrees)] in the θ direction, and the vertical axis represents the gain [dB (decibels)]. A line 101 indicates the position of the point C. A beam pattern 102 indicates a gain characteristic of a refracted wave from a radio wave refraction region in which a refraction angle is set such that the point C is not included in the beam width. A beam pattern 103 indicates a gain characteristic of a refracted wave from a radio wave refraction region set such that the point C is included in the beam width.

A half-width 104 indicates the half-width of the refracted wave from the radio wave refraction region in which the refraction angle is set such that the point C is not included in the beam width. A half-width 105 indicates the half-width of the refracted wave from the radio wave refraction region in which the refraction angle is set such that the point C is included in the beam width. As shown in FIG. 7, the point C is located outside the half-width 104 and inside the half-width 105. As indicated by the beam pattern 102 and the beam pattern 103, the refracted wave from the radio wave refraction region in which the refraction angle is set such that the point C is not included in the beam width and the refracted wave from the radio wave refraction region in which the refraction angle is set such that the point C is not included in the beam width overlap with each other within the half-width 104 and the half-width 105.

Accordingly, in the third embodiment, it is possible to prevent the received power at the position of the point C from becoming larger than necessary. As a result, in the third embodiment, it is possible to prevent the beam width at a position on a hemispherical surface including the point C from being narrowed.

### Fourth Embodiment

A fourth embodiment will be described. When it is attempted to widen the beam width in the far-field region by adjusting only the refraction angle of the radio wave refraction region, a flat beam pattern may not be obtained. FIG. 8 shows a gain characteristic of a refracted wave according to a comparative example of a fourth embodiment. In FIG. 8, the horizontal axis represents the refraction angle [deg], and the vertical axis represents the gain [dB]. A beam pattern 110 indicates a gain characteristic of a refracted wave emitted from the entire radio wave refracting plate 1 (see FIG. 4). A beam pattern 111 indicates a gain characteristic of a refracted wave W2-1 emitted from the first radio wave refraction region 11 (see FIG. 4). A beam pattern 112 indicates a gain characteristic of a refracted wave 2-2 emitted from the second radio wave refraction region 12 (see FIG. 4). The beam pattern 110 is a superposition of the beam pattern 111 and the beam pattern 112.

As indicated by the beam pattern 110, the refracted wave does not have a flat beam pattern in a range 113 that is an angular region in which it is desired to widen the beam width of the refracted wave. This is because the beam pattern 111 has a null point P1 and the beam pattern 112 has a null point P2. The null point P1 and the null point P2 are located within the range 113. Therefore, when the beam pattern 111 and the beam pattern 112 are superimposed on each other, a ripple occurs in the range 113 of the beam pattern 110, and thus a flat beam pattern cannot be obtained in the range 113. Therefore, in the fourth embodiment, a refracted wave having a flat beam pattern is formed by appropriately setting the opening size of each radio wave refraction region.

Here, when the wavelength of the refracted wave is λ, the opening size of each radio wave refraction region is d, the angle of the first null on the high frequency side is α, and the angle of the first null on the low frequency side is β, the following expression (2) is established.

$$\begin{matrix}[ Math 2 ] & \\ α - β = 2 {sin}^{- 1} \frac{λ}{d} & ( 2 )\end{matrix}$$

A range in which it is desired to form a flat beam pattern is represented by Δθ. In this case, it is only necessary to form a beam pattern between the first null on the high frequency side and the first null on the low frequency side, and thus the following expression (3) is established.

$$\begin{matrix}[ Math 3 ] & \\ Δ θ < α - β & ( 3 )\end{matrix}$$

When the expression (3) is established, the null point of the refracted wave emitted from each radio wave refraction region does not fall within the angular region in which it is desired to form a flat beam pattern. That is, by setting the opening size of each radio wave refraction region so as to satisfy the following expression (4), a flat beam pattern can be formed in a desired range.

$$\begin{matrix}[ Math 4 ] & \\ d < \frac{λ}{sin \frac{Δ θ}{2}} & ( 4 )\end{matrix}$$

In the example shown in FIG. 8, the expression (4) is not satisfied, and therefore a flat beam pattern is not obtained in a range 113.

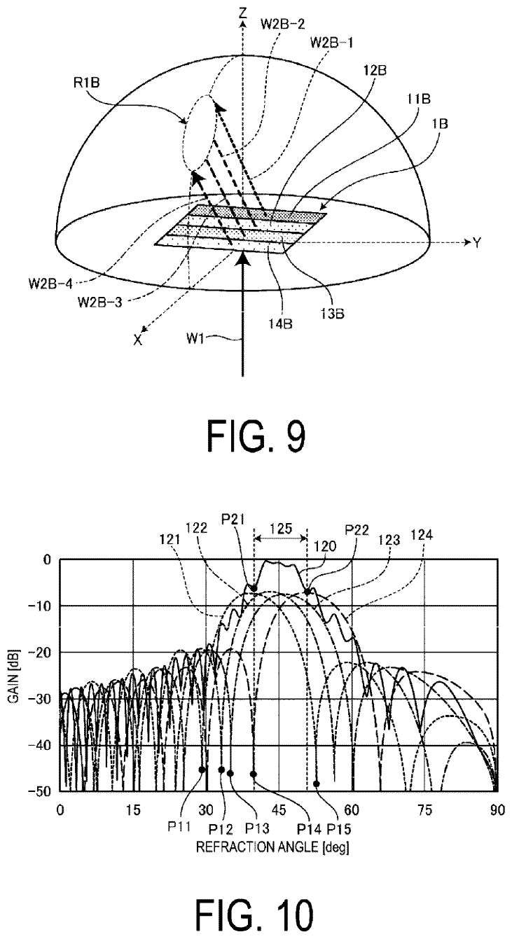

A configuration example of a radio wave refracting plate according to a fourth embodiment will be described with reference to FIG. 9. FIG. 9 illustrates a configuration example of a radio wave refracting plate according to a fourth embodiment. As illustrated in FIG. 9, a radio wave refracting plate 1B includes a first radio wave refraction region 11B, a second radio wave refraction region 12B, a third radio wave refraction region 13B, and a fourth radio wave refraction region 14B. The radio wave refracting plate 1B is divided in the Y-axis direction (horizontal direction) on the XY plane. In each of the first radio wave refraction region 11B to the fourth radio wave refraction region 14B, the size of the opening portion is determined so as to satisfy the expression (4).

The first radio wave refraction region 11B is configured to refract the radio wave W1 and emit a refracted wave W2B-1. For example, the first radio wave refraction region 11B is configured to refract the radio wave W1 by 42.5° in the θ direction.

The second radio wave refraction region 12B is configured to refract the radio wave W1 and emit a refracted wave W2B-2. For example, the second radio wave refraction region 12B is configured to refract the radio wave W1 by 44° in the θ direction.

The third radio wave refraction region 13B is configured to refract the radio wave W1 and emit a refracted wave W2B-3. For example, the third radio wave refraction region 13B is configured to refract the radio wave W1 by 46° in the θ direction.

The fourth radio wave refraction region 14B is configured to refract the radio wave W1 and emit a refracted wave W2B-4. For example, the fourth radio wave refraction region 14B is configured to refract the radio wave W1 by 50° in the θ direction.

That is, among the first radio wave refraction region 11B to the fourth radio wave refraction region 14B, the refraction angle of the radio wave W1 of the first radio wave refraction region 11B is configured to be the gentlest, and the refraction angle of the radio wave W1 of the fourth radio wave refraction region 14B is configured to be the steepest.

FIG. 10 shows a gain characteristic of a refracted wave according to the fourth embodiment. In FIG. 10, the horizontal axis represents the refraction angle [deg], and the vertical axis represents the gain [dB]. A beam pattern 120 indicates a gain characteristic of a refracted wave emitted from the entire radio wave refracting plate 1B. A beam pattern 121 indicates a gain characteristic of a refracted wave W2B-1 emitted from the first radio wave refraction region 11B. A beam pattern 122 indicates a gain characteristic of a refracted wave 2B-2 emitted from the second radio wave refraction region 12B. A beam pattern 123 indicates a gain characteristic of a refracted wave W2B-3 emitted from the third radio wave refraction region 13B. A beam pattern 124 indicates a gain characteristic of a refracted wave W2B-4 emitted from the fourth radio wave refraction region 14B. The beam pattern 120 is a superposition of the beam pattern 121, the beam pattern 122, the beam pattern 123, and the beam pattern 124. The beam pattern 121 has a null point P11. The beam pattern 122 has a null point P12. The beam pattern 123 has a null point P13. The beam pattern 124 has a null point P14.

In the fourth embodiment, as indicated by the beam pattern 120, the refracted wave has a flat beam pattern with less ripples than the beam pattern 110 shown in FIG. 8 in a range 125 that is an angular region in which it is desired to widen the beam width of the refracted wave. This is because the null point P11, the null point P12, the null point P13, and the null point P14 are located outside the range 125. Therefore, in the fourth embodiment, when the beam pattern 121, the beam pattern 122, the beam pattern 123, and the beam pattern 124 are superimposed on one another, it is possible to prevent the occurrence of ripples in the range 125 of the beam pattern 120.

As indicated by the beam pattern 120, the range 125 with a flat beam pattern is formed between the first null (null point P14) of the beam pattern 124 on the low frequency side and the first null (null point P15) of the beam pattern 121 on the high frequency side.

Here, the angles of a peak point P21 and the null point P15 of the beam pattern 121 are θₐ and θ_{a1H}, respectively. The angles of a peak point P22 and the null point P14 of the beam pattern 124 are θ_{d} and θ_{d1L}, respectively. When the range 125 is denoted by Δθ, Δθ is expressed by the following expression (5).

$$\begin{matrix}[ Math 5 ] & \\ Δθ = {θ}_{a 1 H} - {θ}_{d 1 L} & ( 5 )\end{matrix}$$

In general, when the peak angle is γ, the angle of the first null is β, the wavelength of the refracted wave is λ, and the size of the opening portion is d, the following expression (6) is established.

$$\begin{matrix}[ Math 6 ] & \\ \vert γ - β \vert = {sin}^{- 1} \frac{λ}{d} & ( 6 )\end{matrix}$$

Since the expression (6) is established, when the angle of the center at which it is desired to widen the refracted wave is θ, a desired beam pattern can be obtained by determining θₐ and θ_{d} based on the following expression (7) when the range in which it is desired to flatten the refracted wave is determined.

$$\begin{matrix}[ Math 7 ] & \\ {θ}_{a} = θ + \frac{Δ θ}{2} - {sin}^{- 1} \frac{λ}{d} , {θ}_{d} = θ + \frac{Δ θ}{2} + {sin}^{- 1} \frac{λ}{d} & ( 7 )\end{matrix}$$

Specifically, in the fourth embodiment, the size d of each opening portion can be calculated based on the expressions (2) to (4). Then, θₐ and θ_{d} can be calculated by substituting the calculated size d of each opening portion into the expression (7).

As described above, in the fourth embodiment, the size of the opening portion can be calculated based on the angle of the null point of the refracted wave emitted from each radio wave refraction region. In the fourth embodiment, the angle of the peak point of the refracted wave emitted from each radio wave refraction region can be calculated based on the calculated size of the opening portion. Accordingly, in the fourth embodiment, a flat beam pattern can be formed more appropriately within a desired range.

### Fifth Embodiment

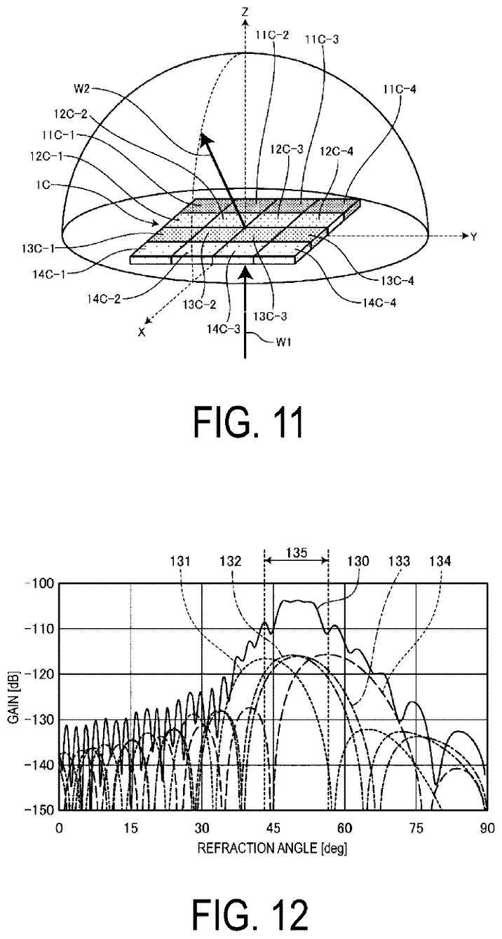

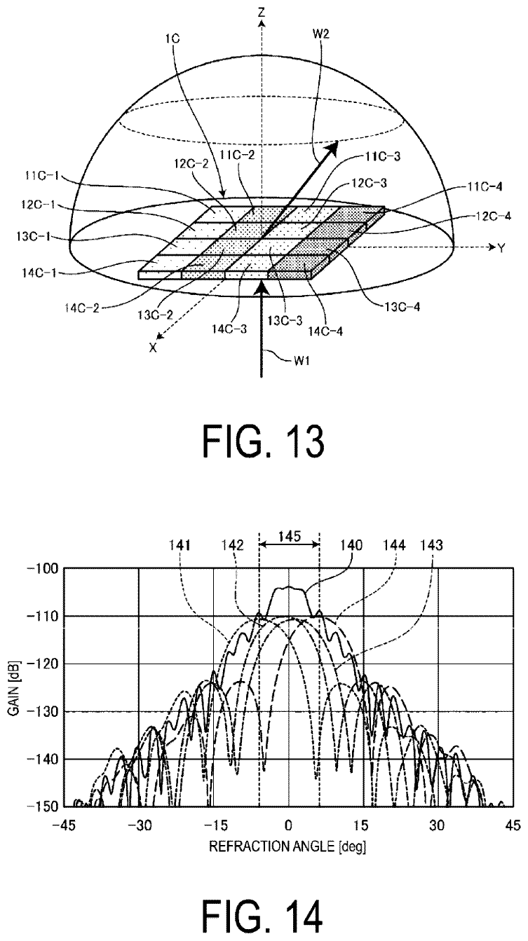

A fifth embodiment will be described with reference to FIG. 11 to FIG. 14. FIG. 11 illustrates the refraction angle in a first direction of a radio wave refracting plate according to a fifth embodiment. FIG. 12 shows a gain characteristic of a refracted wave in the first direction of the radio wave refracting plate according to the fifth embodiment. FIG. 13 illustrates the refraction angle in a second direction of the radio wave refracting plate according to the fifth embodiment. FIG. 14 illustrates the refraction angle in the second direction of the radio wave refracting plate according to the fifth embodiment.

As illustrated in FIG. 11, a radio wave refracting plate 1C includes a first radio wave refraction region 11C-1, a first radio wave refraction region 11C-2, a first radio wave refraction region 11C-3, a first radio wave refraction region 11C-4, a second radio wave refraction region 12C-1, a second radio wave refraction region 12C-2, a second radio wave refraction region 12C-3, a second radio wave refraction region 12C-4, a third radio wave refraction region 13C-1, a third radio wave refraction region 13C-2, a third radio wave refraction region 13C-3, a third radio wave refraction region 13C-4, a fourth radio wave refraction region 14C-1, a fourth radio wave refraction region 14C-2, a fourth radio wave refraction region 14C-3, and a fourth radio wave refraction region 14C-4. That is, the radio wave refracting plate 1C includes 16 radio wave refraction regions. The radio wave refracting plate 1C is configured to refract the radio wave W1 using the 16 radio wave refraction regions and emit a refracted wave W2. The radio wave refracting plate 1C is divided in both the X-axis direction (vertical direction) and the Y-axis direction (horizontal direction) on the XY plane.

The first radio wave refraction region 11C-1, the first radio wave refraction region 11C-2, the first radio wave refraction region 11C-3, and the first radio wave refraction region 11C-4 may be collectively referred to as a first radio wave refraction region group. The second radio wave refraction region 12C-1, the second radio wave refraction region 12C-2, the second radio wave refraction region 12C-3, and the second radio wave refraction region 12C-4 may be collectively referred to as a second radio wave refraction region group. The third radio wave refraction region 13C-1, the third radio wave refraction region 13C-2, the third radio wave refraction region 13C-3, and the third radio wave refraction region 13C-4 may be collectively referred to as a third radio wave refraction region group. The fourth radio wave refraction region 14C-1, the fourth radio wave refraction region 14C-2, the fourth radio wave refraction region 14C-3, and the fourth radio wave refraction region 14C-4 may be collectively referred to as a fourth radio wave refraction region group.

In FIG. 12, the horizontal axis represents the refraction angle [deg] in the θ direction, and the vertical axis represents the gain [dB]. A beam pattern 130 indicates a gain characteristic of a refracted wave in the θ direction emitted from the entire radio wave refracting plate 1C. A beam pattern 131 indicates a gain characteristic of a refracted wave emitted from the first radio wave refraction region group. A beam pattern 132 indicates a gain characteristic of a refracted wave emitted from the second radio wave refraction region group. A beam pattern 133 indicates a gain characteristic of a refracted wave emitted from the third radio wave refraction region group. A beam pattern 134 indicates a gain characteristic of a refracted wave emitted from the fourth radio wave refraction region group. The beam pattern 130 is a superposition of the beam pattern 131, the beam pattern 132, the beam pattern 133, and the beam pattern 134. In the fifth embodiment, as indicated by the beam pattern 130, the radio wave refracting plate 1C can emit a refracted wave having a flat beam pattern in a range 135 between the peak angle of the beam pattern 131 and the peak angle of the beam pattern 134.

FIG. 13 illustrates the refraction angle in a second direction of the radio wave refracting plate according to the fifth embodiment. The first radio wave refraction region 11C-4, the second radio wave refraction region 12C-4, the third radio wave refraction region 13C-4, and the fourth radio wave refraction region 14C-4 may be collectively referred to as a fifth radio wave refraction region group. The first radio wave refraction region 11C-3, the second radio wave refraction region 12C-3, the third radio wave refraction region 13C-3, and the fourth radio wave refraction region 14C-3 may be collectively referred to as a sixth radio wave refraction region group. The first radio wave refraction region 11C-2, the second radio wave refraction region 12C-2, the third radio wave refraction region 13C-2, and the fourth radio wave refraction region 14C-2 may be collectively referred to as a seventh radio wave refraction region group. The first radio wave refraction region 11C-1, the second radio wave refraction region 12C-1, the third radio wave refraction region 13C-1, and the fourth radio wave refraction region 14C-1 may be collectively referred to as an eighth radio wave refraction region group.

In FIG. 14, the horizontal axis represents the refraction angle [deg] in the φ direction, and the vertical axis represents the gain [dB]. A beam pattern 140 indicates a gain characteristic of a refracted wave in the φ direction emitted from the entire radio wave refracting plate 1C. A beam pattern 141 indicates a gain characteristic of a refracted wave emitted from the fifth radio wave refraction region group. A beam pattern 142 indicates a gain characteristic of a refracted wave emitted from the sixth radio wave refraction region group. A beam pattern 143 indicates a gain characteristic of a refracted wave emitted from the seventh radio wave refraction region group. A beam pattern 144 indicates a gain characteristic of a refracted wave emitted from the eighth radio wave refraction region group. The beam pattern 140 is a superposition of the beam pattern 141, the beam pattern 142, the beam pattern 143, and the beam pattern 144. In the fifth embodiment, as indicated by the beam pattern 140, the radio wave refracting plate 1C can emit a refracted wave having a flat beam pattern in a range 145 between the peak angle of the beam pattern 141 and the peak angle of the beam pattern 144.

Also in the fifth embodiment, θₐ and θ_{d} can be calculated by calculating the size d of each opening portion based on the expressions (2) to (4) and substituting the calculated size d of each opening portion into the expression (7). The expressions (5) to (7) are the same for the φ direction, and thus description thereof is omitted.

As described above, in the fifth embodiment, the size of the opening portion can be calculated based on the angle of the null point of the refracted wave emitted from each radio wave refraction region. In the fifth embodiment, the angle of the peak point of the refracted wave emitted from each radio wave refraction region can be calculated based on the calculated size of the opening portion. Accordingly, in the fifth embodiment, a flat beam pattern can be formed more appropriately within a desired range.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1, 1a, 1A, 1B Radio wave refracting plate
3 Base station
4 Reception device
10a, 10b, 10c, 10d Unit structure
11, 11A, 11B First radio wave refraction region
12, 12A, 12B Second radio wave refraction region
13B Third radio wave refraction region
14B Fourth radio wave refraction region

1. A radio wave refracting plate comprising:
a plurality of unit structures arrayed in a first surface direction; and
a plurality of radio wave refraction regions comprising the plurality of unit structures and having different refraction angles in a first angular direction with respect to a radio wave.

2. The radio wave refracting plate according to claim 1, wherein
the plurality of radio wave refraction regions are regions divided in both a vertical direction and a horizontal direction.

3. The radio wave refracting plate according to claim 1 or 2, wherein
the plurality of radio wave refraction regions are formed so as to have different refraction angles in the first angular direction and a second angular direction different from the first angular direction with respect to the radio wave.

4.-7. (canceled)
